(19) United States
(12) Patent Application Publication
(10) Pub. No.: US 2025/0070335 A1
(43) Pub. Date: Feb. 27, 2025

(54) SECONDARY BATTERY

(71) Applicant: Samsung SDI Co., Ltd., Yongin-si (KR)

(72) Inventor: Bohoon Kim, Yongin-si (KR)

(21) Appl. No.: 18/646,476

(22) Filed: Apr. 25, 2024

(30) Foreign Application Priority Data
Aug. 23, 2023 (KR) 10-2023-0110492

(51) Int. Cl. H01M 50/15; H01M 50/103; H01M 50/169; H01M 50/184; H01M 50/186; H01M 50/342; H01M 50/578

(52) U.S. Cl. CPC H01M 50/15; H01M 50/103; H01M 50/169; H01M 50/184; H01M 50/186; H01M 50/3425; H01M 50/578; H01M 2200/20

(57) ABSTRACT

Disclosed is a secondary battery that reduces or prevents heat transfer from a battery cell to surroundings thereof if an event occurs in the battery cell. The secondary battery includes an electrode assembly including a first electrode plate and a second electrode plate including an electrode uncoated portion protruding from one side, a case for receiving the electrode assembly, and defining a lower opening at a lower end, a cap assembly at one surface of the case for sealing the case, and including an electrode terminal electrically connected to the electrode uncoated portion, and a sealing plate coupled along a perimeter of the case at the lower opening.

### CROSS-REFERENCE TO THE RELATED APPLICATION

The present application claims priority to and the benefit of Korean Patent Application No. 10-2023-0110492, filed on Aug. 23, 2023, in the Korean Intellectual Property Office, the entire disclosure of which is incorporated herein by reference.

### BACKGROUND

### 1. Field

Embodiments relate to a secondary battery.

### 2. Description of the Related Art

A secondary battery is a battery that can be charged and discharged, unlike a primary battery, which cannot be charged. A low-capacity battery having a single battery cell, and packaged in the form of a pack, may be used in small portable electronic devices, such as a cell phone and a camcorder, and a large-capacity battery including dozens of battery packs connected to each other may be widely used as a power source for driving a motor of a hybrid electric vehicle.

The secondary battery is manufactured in a variety of shapes, including a cylindrical shape and a prismatic shape. The secondary battery is manufactured by receiving an electrode assembly, which includes a positive electrode plate, a negative electrode plate, a separator that is an insulator and that is interposed between the positive electrode plate and the negative electrode plate, and an electrolyte in a case, and by coupling a cap plate to the case. The electrode assembly is electrically connected to an electrode terminal via a current collector. The internal volume of the case varies depending on the structure of the current collector. It may be desirable to provide a secondary battery having a larger capacity within a given size.

### SUMMARY

Embodiments provide a secondary battery that reduces or prevents heat of a battery cell from being transferred to the surroundings thereof if an event occurs in the battery cell.

A secondary battery according to one or more embodiments includes an electrode assembly including a first electrode plate and a second electrode plate including an electrode uncoated portion protruding from one side, a case for receiving the electrode assembly, and defining a lower opening at a lower end, a cap assembly at one surface of the case for sealing the case, and including an electrode terminal electrically connected to the electrode uncoated portion, and a sealing plate coupled along a perimeter of the case at the lower opening.

The sealing plate may be coupled along the perimeter by welding.

The sealing plate may be welded along the perimeter with a welding depth of about 300 μm to about 400 μm.

A breaking pressure of the sealing plate may be about 7 bar to about 10 bar.

The case may have a larger area than the electrode assembly, and may be sealed by the sealing plate.

At least three sides of the sealing plate may be configured to be fractured from the case upon an internal pressure of the case reaching a fracture pressure.

The electrode assembly may be configured to be separated from the cap assembly and to fall out of the case upon the sealing plate being fractured from the case.

The electrode assembly may be configured to be separated from the cap assembly at a part where the electrode assembly and the cap assembly are welded to each other upon the sealing plate being fractured from the case.

The case may further define an upper opening at an upper end, wherein the cap assembly is coupled to the case at the upper opening, and wherein the sealing plate is coupled to the case at the lower opening.

The cap assembly may include a cap plate for sealing the case at the upper opening, wherein the electrode terminal extends through the cap plate, and is electrically connected to the electrode assembly, and wherein the sealing plate is coupled to the cap plate.

The cap plate might not include a vent.

The case may further define side openings respectively at opposite sides, wherein the cap assembly is coupled to the case at the side openings.

The cap assembly may include a pair of cap plates for sealing the side openings, and electrode terminals respectively extending through the cap plates and electrically connected to the electrode assembly, wherein the sealing plate is coupled between the cap plates.

The electrode assembly may be between the pair of the cap plates adjacent a lower part of the electrode assembly.

Respective ends of the electrode assembly may be coupled to the pair of the cap plates.

### BRIEF DESCRIPTION OF THE DRAWINGS

The accompanying drawings, which are incorporated in this specification, illustrate embodiments, and serve to further illustrate the present disclosure in conjunction with the detailed description of embodiments that follows, and the disclosure is not to be construed as limited to what is shown in such drawings. In the drawings:

FIG. 1 is a perspective view showing a secondary battery according to one or more embodiments;

FIG. 2 is a rear perspective view showing the secondary battery according to one or more embodiments;

FIG. 3a is a sectional view taken along the line A-A′ of FIG. 1;

FIG. 3b is an enlarged view of part P of FIG. 3a;

FIG. 4 is an exploded perspective view showing the coupling relationship between an electrode assembly and a current collector;

FIG. 5 shows temperature change over time if an event occurs in the secondary battery according to one or more embodiments;

FIG. 6 is a perspective view showing a secondary battery according to one or more other embodiments;

FIG. 7a is a sectional view taken along the line B-B′ of FIG. 6;

FIG. 7b is an enlarged view of part P of FIG. 7a;

FIG. 8 is a partial sectional view showing the coupling relationship between an electrode assembly and an electrode terminal in the secondary battery according to one or more other embodiments; and

FIG. 9 is a partial perspective view showing the coupling relationship between the electrode assembly and an insulating plate in the secondary battery according to one or more other embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure. The present disclosure covers all modifications, equivalents, and replacements within the idea and technical scope of the present disclosure. Further, each of the features of the various embodiments of the present disclosure may be combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a resistor, a capacitor, and/or the like. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

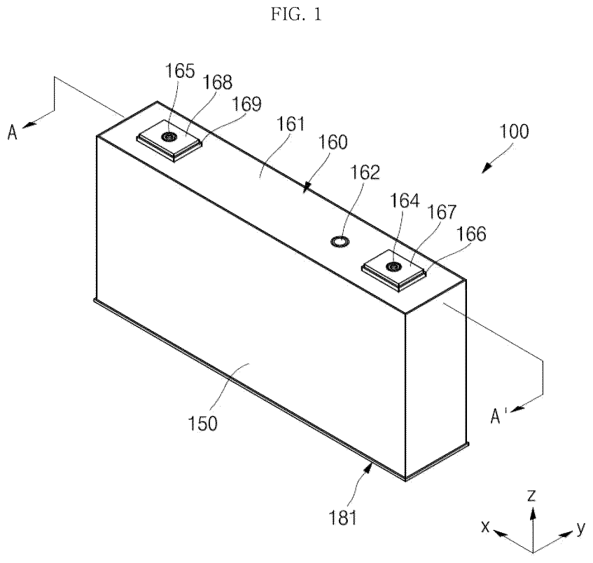

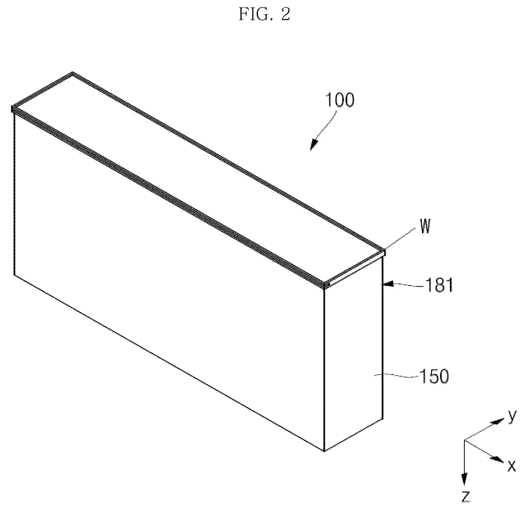

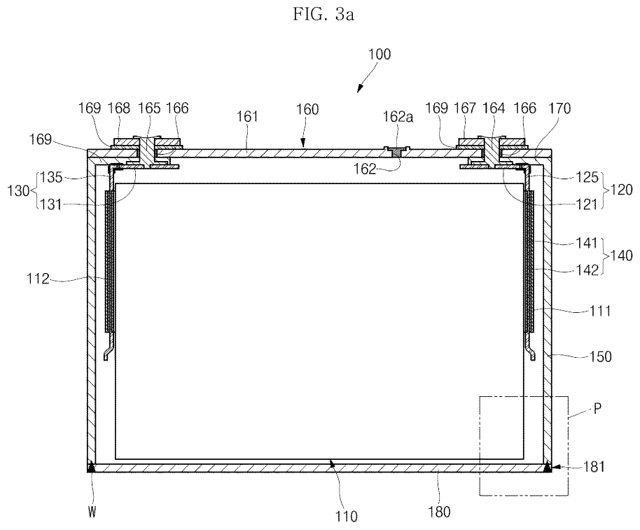

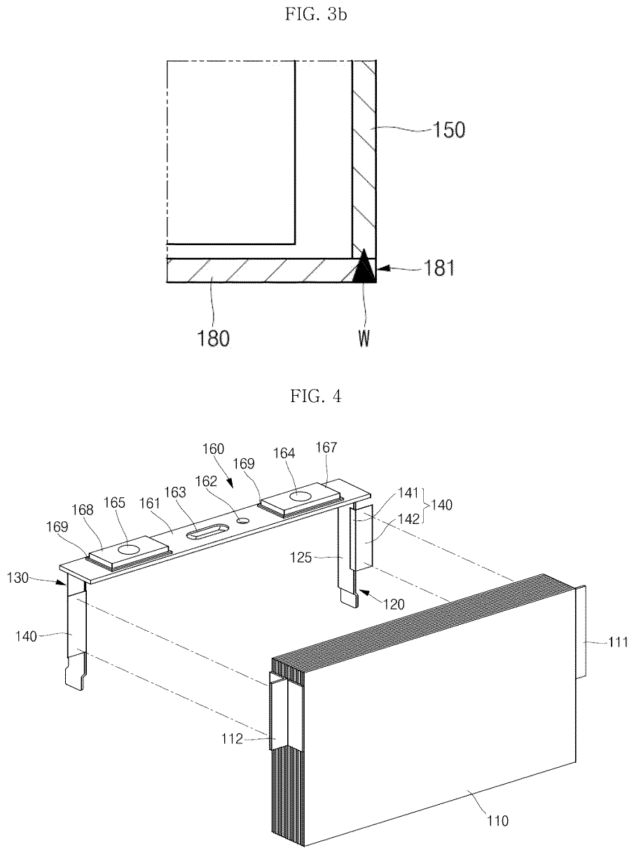

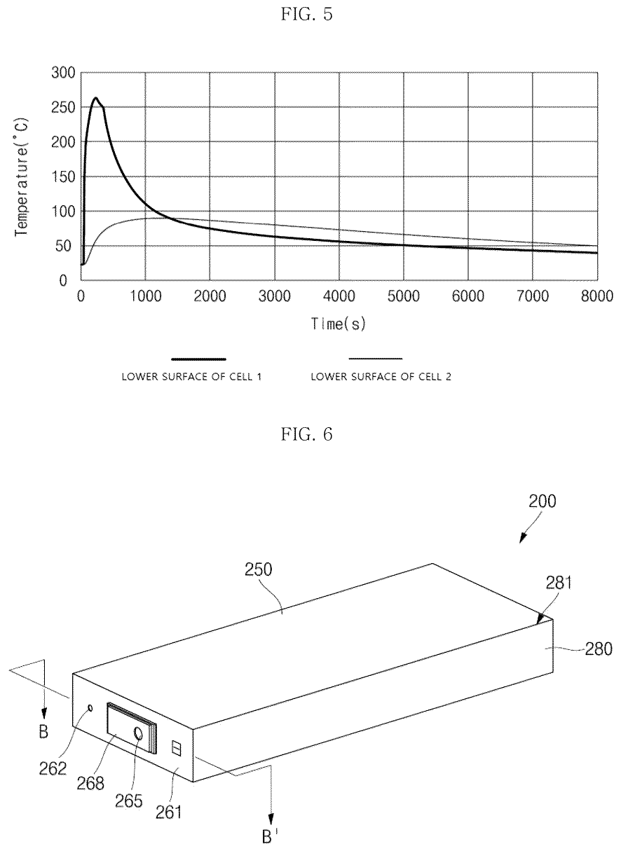

FIG. 1 is a perspective view showing a secondary battery according to one or more embodiments. FIG. 2 is a rear perspective view showing the secondary battery according to one or more embodiments. FIG. 3a is a sectional view taken along the line A-A′ of FIG. 1. FIG. 3b is an enlarged view of part P of FIG. 3a. FIG. 4 is an exploded perspective view showing the coupling relationship between an electrode assembly and a current collector. FIG. 5 shows temperature change over time if an event occurs in the secondary battery according to one or more embodiments.

Referring to FIGS. 1, 2, and 3, the secondary battery 100 according to one or more embodiments may include an electrode assembly 110, a current collector(s) 120 and 130 (e.g., current collection unit(s)), an auxiliary tab 140, a case 150, a cap assembly 160, and a sealing plate 180.

The electrode assembly 110 may be formed by stacking a plurality of laminates including a first electrode plate, a separator, and a second electrode plate, which may be formed as a thin plate or a membrane. The first electrode plate may operate as a positive electrode, and the second electrode plate may operate as a negative electrode. The first electrode plate and the second electrode plate may have different respective polarities, as may be selected by those skilled in the art.

The first electrode plate may be formed by applying a first electrode active material, such as a transition metal oxide, to a first electrode current collector made of metal foil, such as aluminum. The first electrode plate may include a first electrode uncoated portion 111, which is a region to which no first electrode active material is applied. The first electrode uncoated portion 111 may provide a passage for current flow between the first electrode plate and the outside.

The first electrode uncoated portion 111 may commonly overlap at the same position if the first electrode plate is stacked, thereby constituting a multi-tab structure. The first electrode uncoated portion 111 may protrude from one side of the electrode assembly 110, and a plurality of first electrode uncoated portions may be welded to each other to form a single first current collection tab. The first electrode uncoated portions 111/first current collection tab may be integrally formed with the first electrode plate, and may be withdrawn from each of the stacked first electrode plates, thereby increasing efficiency of current collection from the electrode assembly 110. The first electrode uncoated portion 111/first current collection tab may be made of a member that is separate from the first electrode plate by selection of those skilled in the art.

The second electrode plate may be formed by applying a second electrode active material, such as graphite or carbon, to a second electrode current collector made of metal foil, such as copper or nickel, and may include a second electrode uncoated portion 112, which is a region to which no second electrode active material is applied.

The second electrode uncoated portion 112 may commonly overlap at a position if the second electrode plate is stacked, thereby constituting a multi-tab structure. The second electrode uncoated portion 112 may protrude from the other side of the electrode assembly 110, and a plurality of second electrode uncoated portions may be welded to each other to form a single second current collection tab.

The separator may be located between the first and second electrode plates to reduce or prevent the likelihood of a short circuit, and to allow movement of lithium ions. The separator may be made of polyethylene, polypropylene, or a composite film of polyethylene and polypropylene. The scope of the disclosure is not limited by the material of the separator.

The electrode assembly 110 may be received in the case 150 with an electrolyte. The electrolyte may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF₆ or LiBF₄. The electrolyte may be liquid, solid, or gel.

The current collector(s) 120 and 130 may include a first current collector 120 electrically connected to the first electrode plate, and a second current collector 130 electrically connected to the second electrode plate.

The first current collector 120 may be made of a conductive material, such as aluminum, and may be electrically connected to the first electrode plate by contacting the first electrode uncoated portion 111 protruding from one end of the electrode assembly 110. The first current collector 120 may include a first terminal connection portion 121 and a first electrode connection portion 125. A bent region may be formed between the first terminal connection portion 121 and the first electrode connection portion 125.

The first terminal connection portion 121 may be located above the electrode assembly 110, and may be parallel to a cap plate 161, a description of which will follow. The first terminal connection portion 121 may be located between the electrode assembly 110 and the cap plate 161, and may be formed in the shape of a roughly flat plate. A first terminal 164, a description of which will follow, may be coupled to the first terminal connection portion 121. The first electrode connection portion 125 may be bent at an end of the first terminal connection portion 121, and may extend downwardly. The first electrode connection portion 125 may be formed at one side of the electrode assembly 110. The first electrode connection portion 125 may be coupled to the first electrode uncoated portion 111 either directly or via the auxiliary tab 140, which is optionally coupled to the first electrode connection portion 125.

The second current collector 130 may be made of a conductive material, such as nickel, and may be electrically connected to the second electrode plate by contacting the second electrode uncoated portion 112 protruding from the other end of the electrode assembly 110. The second current collector 130 may include a second terminal connection portion 131 and a second electrode connection portion 135. A bent region may be formed between the second terminal connection portion 131 and the second electrode connection portion 135. A second terminal 165 may be electrically connected to the second terminal connection portion 131, and the auxiliary tab 140 may be optionally coupled to the second electrode connection portion 135. The second terminal connection portion 131 may be coupled to the second electrode uncoated portion 112 either directly or via the auxiliary tab 140. The second current collector 130 may be identical in shape to the first current collector 120, and a duplicate description thereof will be omitted.

The auxiliary tabs 140 may be respectively electrically coupled to the first electrode connection portion 125 and the second electrode connection portion 135. The auxiliary tabs 140 coupled to the first and second electrode connection portions 125 and 135 may have the same shape, and may be made of different materials. For example, the auxiliary tab 140 coupled to the first electrode connection portion 125 may be made of aluminum or an aluminum alloy, and the auxiliary tab 140 coupled to the second electrode connection portion 135 may be made of copper or a copper alloy. Because other configurations of the auxiliary tabs 140 are the same, the auxiliary tab 140 coupled to the first electrode connection portion 125 will hereinafter be described by way of example.

One end of the auxiliary tab 140 may be fixed to the first electrode connection portion 125 by welding. The auxiliary tab 140 and the first electrode connection portion 125 may be welded to each other using laser welding, resistance welding, ultrasonic welding, or the like. The other end of the auxiliary tab 140 may have an L-shape bent from the first electrode connection portion 125.

The first electrode uncoated portion 111 of the electrode assembly 110 may be welded to the other end of the auxiliary tab 140. With the first electrode uncoated portion 111 welded, the auxiliary tab 140 may be bent once again such that the first electrode uncoated portion 111 faces the case 150 outside the second electrode connection portion 135. The auxiliary tab 140 and the first electrode uncoated portion 111 may be located between the electrode assembly 110 and the case 150 in sequential order from the electrode assembly 110.

The auxiliary tabs 140 may be respectively integrally formed with the first electrode connection portion 125 and the second electrode connection portion 135. Optionally, in one or more embodiments, the auxiliary tab 140 may be omitted, and the first electrode uncoated portion 111 and the second electrode uncoated portion 112 may be respectively directly welded to the first electrode connection portion 125 and the second electrode connection portion 135.

The case 150 may be made of a conductive metal, such as aluminum, an aluminum alloy, or nickel-plated steel. The case 150 may have, or may define, an upper opening configured to allow the electrode assembly 110 to be inserted and seated therethrough, and may have/define a lower opening corresponding thereto, thereby having an overall hexahedral shape with no top and no bottom. The cap plate 161 may be coupled to the upper opening of the case 150 to seal the case 150.

An inner surface of the case 150 may be insulated to reduce or prevent the likelihood of electrical short circuit therein. In other embodiments, one electrode of the electrode assembly 110 may be electrically connected to the case 150 via the cap plate 161. The inner surface of the case 150 may be insulated to reduce or prevent the likelihood of electrical short circuit therein. For example, the case 150 may operate as a positive electrode.

The cap assembly 160 may be coupled to the case at the upper opening of the case 150. The cap assembly 160 may include a cap plate 161, an electrolyte inlet 162, a first terminal 164, a second terminal 165, a gasket 166, a first terminal plate 167, a second terminal plate 168, a fastening plate 169, and a lower insulating member 170.

The cap plate 161 may seal the upper opening of the case 150, and may be made of the same material as the case 150. For example, the cap plate 161 may be coupled to the case 150 by laser welding. The cap plate 161 may be electrically independent, or may be electrically connected to one of the first current collector 120 and the second current collector 130.

The electrolyte inlet 162 for injecting an electrolyte may be formed in, or defined by, the cap plate 161. An electrolyte may be injected into the case 150 through the electrolyte inlet 162, after which the electrolyte inlet 162 may be sealed by a stopper 162a.

Each of the first terminal 164 and the second terminal 165 may extend through the cap plate 161. The first terminal 164 may be coupled to the first terminal connection portion 121, and may be electrically connected to the first current collector 120. The second terminal 165 may be coupled to the second terminal connection portion 131, and may be electrically connected to the second current collector 130.

The gasket(s) 166 may be formed between the cap plate 161 and the first and second terminals 164 and 165. The gasket(s) 166 may wrap the outer side of each of the first and second terminals 164 and 165, and may be made of an insulating material. The gasket 166 may seal between the cap plate 161 and the first and second terminals 164 and 165. The gasket 166 may reduce or prevent permeation of external moisture into the secondary battery 100, or may reduce or prevent leakage of the electrolyte received in the secondary battery 100.

The first terminal plate 167 may be coupled to the first terminal 164 protruding above the cap plate 161. After the first terminal plate 167 is coupled to the first terminal 164, the first terminal plate 167 may be fixed to the first terminal 164 by riveting an upper part of the first terminal 164, or by welding an interface between the first terminal plate 167 and the first terminal 164.

The second terminal plate 168 may be coupled to the second terminal 165 protruding above the cap plate 161. After the second terminal plate 168 is coupled to the second terminal 165, the second terminal plate 168 may be fixed to the second terminal 165 by riveting an upper part of the second terminal 165, or by welding an interface between the second terminal plate 168 and the second terminal 165.

The fastening plates 169 may be respectively formed between the cap plate 161 and the first terminal plate 167, and formed between the cap plate 161 and the second terminal plate 168. Each of the fastening plates 169 may be made of an insulating material, in one or more embodiments. In one or more embodiments, only one of the fastening plates 169 may be made of an electrically conductive material. For example, the fastening plate 169 located under the first terminal plate 167 may be made of a conductive material, and the fastening plate 169 located under the second terminal plate 168 may be made of an insulating material. The first terminal 164 may have the same polarity as the cap plate 161. If each of the fastening plates 169 is made of an insulating material, the first terminal 164 and the second terminal 165 may be electrically isolated from the cap plate 161.

The lower insulating member 170 may be formed between the first current collector 120 and the cap plate 161, and between the second current collector 130 and the cap plate 161, to electrically insulate the first and second current collectors 120 and 130 from the cap plate 161.

The sealing plate 180 may be configured to seal the lower opening of the case 150. The sealing plate 180 may be rectangular in shape so as to correspond to the lower opening of the case 150, and may be coupled along the opening of the case 150 by welding W. For ease of welding, and to increase coupling force, the sealing plate 180 may be made of the same material as the case 150.

The sealing plate 180 may be coupled to the case 150 by welding W at the position where an edge region 181 of the sealing plate 180 is connected to the case 150 along the lower opening of the case 150. Welding strength may be determined depending on the depth of welding W. The depth of welding W at the edge region 181 of the sealing plate 180 may be set to about 300 μm to about 400 μm. At this depth, coupling between the sealing plate 180 and the case 150 may be maintained until the pressure reaches a threshold pressure (e.g., a predetermined pressure), and the sealing plate 180 and the case 150 may be separated from each other if the pressure exceeds the threshold pressure (e.g., predetermined pressure). If the depth is set from about 300 μm to about 400 μm to weld the sealing plate 180, the breaking pressure, or fracture pressure, of the sealing plate 180 may be set from about 7 bar to 10 bar. If the breaking pressure is about 7 bar or more, the pressure resistance of the case 150 and the sealing plate 180 may be guaranteed to maintain stability of the operation under normal conditions. If the breaking pressure is set to about 10 bar or less, the sealing plate 180 may be opened at the same level as the operation of an existing vent if an event occurs in a battery cell.

In the secondary battery 100 according to one or more embodiments, the sealing plate 180 may be fractured from a lower end of the case 150 if an event occurs, instead of providing a separate vent 163 in the cap plate 161 (e.g., the vent 163 in the cap plate 161 may be omitted, or not included). If the internal pressure of the case 150 reaches a set fracture pressure, at least three of four sides of the sealing plate 180 coupled to the case 150 may be concurrently or substantially simultaneously fractured by the internal pressure. The sealing plate 180 may open the lower end of the case 150, and the electrode assembly 110 in the case 150 may be exposed in a downward direction. If the lower part of the case 150 is opened while the case 150 is under pressure, the electrode assembly 110 may be pushed in the open direction. The electrode assembly 110 may be coupled to the auxiliary tab(s) 140 (or to the current collectors 120 and 130, if the auxiliary tab 140 is omitted) via the first electrode uncoated portion 111 and the second electrode uncoated portion 112, each of which may be formed in the shape of relatively thin foil. The part of the electrode assembly 110 where the first electrode uncoated portion 111 and the second electrode uncoated portion 112 are welded to the auxiliary tab 140 may be fractured, whereby the electrode assembly 110 may be separated from the auxiliary tab 140, and may be discharged out of the case 150 through the open lower part of the case 150. The electrode assembly 110 that has ignited in the battery cell where the event occurred may be ejected to the outside of the case 150 and, in one or more embodiments, may be received in an external cooling/extinguishing solvent or the like. The electrode assembly 110 may be separated and ejected from the battery cell where the event occurred, thereby reducing or preventing propagation of heat to neighboring battery cells.

In the secondary battery 100 according to one or more embodiments, as described above, the sealing plate 180 may be fractured from the case 150 if the internal pressure of the battery cell where the event occurred reaches a fracture pressure (e.g., predetermined fracture pressure), whereby the electrode assembly 110 may be ejected underneath the case 150, and may be quickly separated from the surrounding battery cells to reduce or prevent heat propagation.

Hereinafter, the operation of the secondary battery according to one or more embodiments will be described in more detail.

FIG. 5 shows temperature change over time if an event occurs in the secondary battery according to one or more embodiments.

Referring to FIG. 5, the temperature of a lower surface of cell 1, where an event occurred, may be compared to the temperature of a lower surface of cell 2 adjacent thereto. If the event occurs in cell 1, the temperature may rapidly rise to about 270 degrees. As previously described, the electrode assembly 110 of cell 1 may be ejected through the lower part of the case 150, and the temperature of cell 1 may drop back down from 270 degrees.

The temperature of cell 2 may initially rise to about 80 degrees in response to the event in cell 1, but the temperature of cell 2 might not rise any higher, and then may gradually decrease. The experiment shows that propagation of heat, which may be caused by the event in cell 1, to cell 2, which is adjacent to cell 1, may be reduced or prevented.

Hereinafter, the configuration of a secondary battery according to one or more other embodiments will be described.

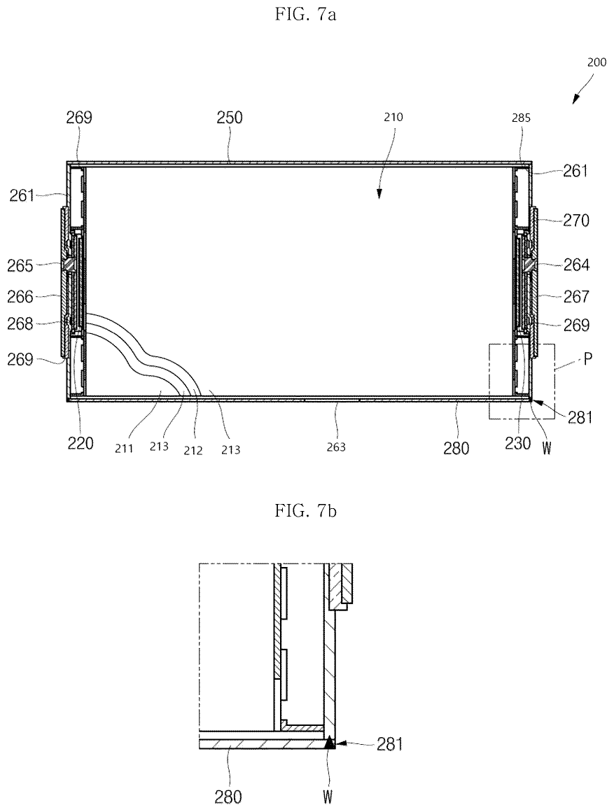

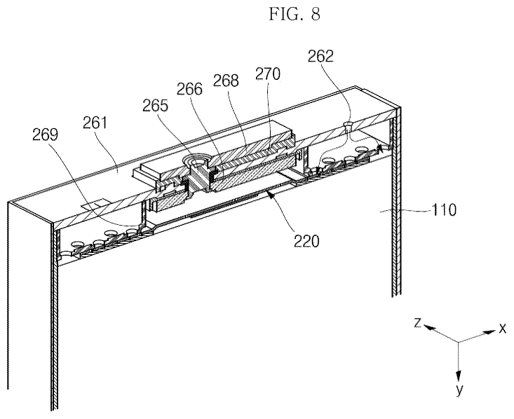

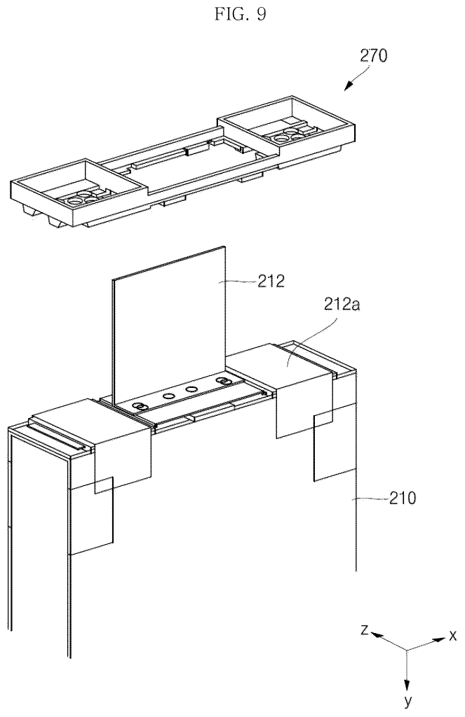

FIG. 6 is a perspective view showing a secondary battery according to one or more other embodiments. FIG. 7a is a sectional view taken along the line B-B′ of FIG. 6. FIG. 7b is an enlarged view of part P of FIG. 7a. FIG. 8 is a partial sectional view showing the coupling relationship between an electrode assembly and an electrode terminal in the secondary battery according to one or more other embodiments. FIG. 9 is a partial perspective view showing the coupling relationship between the electrode assembly and an insulating plate in the secondary battery according to one or more other embodiments.

Referring to FIGS. 6 to 9, the secondary battery 200 according to one or more other embodiments may include an electrode assembly 210, a case 250, a cap assembly 260, and a sealing plate 280.

The electrode assembly 210 may be formed by winding or stacking a laminate including a first electrode plate, a separator, and a second electrode plate, each of which may be formed as a thin plate or a membrane. In the previous embodiments, the first electrode uncoated portion 111 and the second electrode uncoated portion 112 may be formed at the upper part of the electrode assembly 110. In the secondary battery 200 according to one or more other embodiments, a first electrode uncoated portion 211 and a second electrode uncoated portion 212 of the electrode assembly 210 may be respectively formed at opposites side of the electrode assembly 210. A fixing tape 212a may be formed at a stacked edge of the electrode assembly 210, as may be suitable in one or more embodiments. This may be identical or similar in construction to previous embodiments except for orientations of the electrode uncoated portions 211 and 212.

The case 250 may be made of a conductive metal, such as aluminum, an aluminum alloy, or nickel-plated steel, and may be open at opposite sides and at the bottom thereof. The cap assembly 260 may be coupled to opposite sides of the case 250 to form positive and negative terminals.

The cap assembly 260 may be coupled to openings formed in the opposite sides of the case 250. The cap assembly 260 may be electrically coupled to the first electrode uncoated portion 211 and the second electrode uncoated portion 212 of the electrode assembly 210. The cap assembly 260 may include a cap plate 261, an electrolyte inlet 262, a first terminal 264, a second terminal 265, a gasket 266, a first terminal plate 267, a second terminal plate 268, a fastening plate 269, and a lower insulating member 270.

The cap plate 261 may seal the opening formed at each of the opposite ends of the case 250, and may be made of the same material as the case 250. An electrolyte inlet 262 for injecting an electrolyte may be formed in the cap plate 261.

Each of the first terminal 264 and the second terminal 265 may extend through the cap plate 261. The first terminal 264 may be electrically connected to the first electrode uncoated portion 211. The second terminal 265 may be electrically connected to the second electrode uncoated portion 212.

The gasket 266 may be formed between each of the first and second terminals 264 and 265 and the cap plate 261.

The first terminal plate 267 may be coupled to the first terminal 264 protruding above the cap plate 261. The second terminal plate 268 may be coupled to the second terminal 265 protruding above the cap plate 261.

The fastening plates 269 may be formed between the cap plate 261 and the first terminal plate 267 and between the cap plate 261 and the second terminal plate 268. Each of the fastening plates 269 may be made of an insulating material, or only one of the fastening plates may be made of an electrically conductive material.

The lower insulating member 270 may be formed between a first current collector 220 and the cap plate 261, and between a second current collector 230 and the cap plate 261, to electrically insulate the first and second current collectors 220 and 230 from the cap plate 261.

The sealing plate 280 may be coupled to an opening at a lower part of the case 250. The sealing plate 280 may be rectangular in shape so as to correspond to the lower opening of the case 250, and may be coupled along the opening of the case 250 by welding. If the sealing plate 280 is coupled to the case 250 by welding W at the position where the sealing plate 280 is connected to the case 250 along the lower opening of the case 250, welding strength may be determined depending on the depth of welding W. In the secondary battery 200 according to the one or more other embodiments, the depth of welding W at the sealing plate 280 may be set from about 300 μm to about 400 μm. If the depth is set from about 300 μm to about 400 μm to weld the sealing plate 280, the breaking pressure of the sealing plate 280 may be set from about 7 bar to about 10 bar. If the breaking pressure is about 7 bar or more, the pressure resistance of the case 250 and the sealing plate 280 may be guaranteed to maintain stability of the operation under normal conditions. If the breaking pressure is set to about 10 bar or less, the sealing plate 280 may be opened at the same level as the operation of an existing vent if an event occurs in a battery cell.

Because the first electrode uncoated portion 211 and the second electrode uncoated portion 212 of the electrode assembly 210, each of which may be formed in the shape of thin foil, are welded to the respective terminals 264 and 265, the first electrode uncoated portion 211 and the second electrode uncoated portion 212 may be separated and ejected below the case 150 upon opening of the sealing plate 280.

In the secondary battery 200 according to one or more other embodiments, as described above, the sealing plate 280 may be fractured from the case 250 if the internal pressure of the battery cell, which experiences the occurrence of an event, reaches a fracture pressure (e.g., predetermined fracture pressure), whereby the electrode assembly 210 may be ejected under the case 250 to be quickly separated from the surrounding battery cells to reduce or prevent heat propagation.

As is apparent from the above description, in a secondary battery according to one or more embodiments, a sealing plate may be fractured and separated from a case if the internal pressure of a battery cell where an event occurred reaches a fracture pressure (e.g., predetermined fracture pressure), whereby an electrode assembly may be ejected to an exterior of the case, and it is possible to quickly separate the electrode assembly from the surrounding battery cells to reduce or prevent heat propagation.

The above are only examples for implementing a secondary battery according to the disclosure, the disclosure is not limited to the above, and various modifications can be made to the disclosed embodiments by anyone having ordinary skill in the art to which the disclosure pertains without departing from the gist of the disclosure as claimed in the following claims, with functional equivalents thereof to be included therein.

What is claimed is:

1. A secondary battery comprising:
an electrode assembly comprising a first electrode plate and a second electrode plate comprising an electrode uncoated portion protruding from one side;
a case for receiving the electrode assembly, and defining a lower opening at a lower end;
a cap assembly at one surface of the case for sealing the case, and comprising an electrode terminal electrically connected to the electrode uncoated portion; and
a sealing plate coupled along a perimeter of the case at the lower opening.

2. The secondary battery as claimed in claim 1, wherein the sealing plate is coupled along the perimeter by welding.

3. The secondary battery as claimed in claim 2, wherein the sealing plate is welded along the perimeter with a welding depth of about 300 μm to about 400 μm.

4. The secondary battery as claimed in claim 1, wherein a breaking pressure of the sealing plate is about 7 bar to about 10 bar.

5. The secondary battery as claimed in claim 1, wherein the case has a larger area than the electrode assembly, and is sealed by the sealing plate.

6. The secondary battery as claimed in claim 1, wherein at least three sides of the sealing plate are configured to be fractured from the case upon an internal pressure of the case reaching a fracture pressure.

7. The secondary battery as claimed in claim 6, wherein the electrode assembly is configured to be separated from the cap assembly and to fall out of the case upon the sealing plate being fractured from the case.

8. The secondary battery as claimed in claim 6, wherein the electrode assembly is configured to be separated from the cap assembly at a part where the electrode assembly and the cap assembly are welded to each other upon the sealing plate being fractured from the case.

9. The secondary battery as claimed in claim 1, wherein the case further defines an upper opening at an upper end,
wherein the cap assembly is coupled to the case at the upper opening, and
wherein the sealing plate is coupled to the case at the lower opening.

10. The secondary battery as claimed in claim 9, wherein the cap assembly comprises a cap plate for sealing the case at the upper opening,
wherein the electrode terminal extends through the cap plate, and is electrically connected to the electrode assembly, and
wherein the sealing plate is coupled to the cap plate.

11. The secondary battery as claimed in claim 10, wherein the cap plate does not comprise a vent.

12. The secondary battery as claimed in claim 1, wherein the case further defines side openings respectively at opposite sides, and
wherein the cap assembly is coupled to the case at the side openings.

13. The secondary battery as claimed in claim 12, wherein the cap assembly comprises a pair of cap plates for sealing the side openings, and electrode terminals respectively extending through the cap plates and electrically connected to the electrode assembly, and
wherein the sealing plate is coupled between the cap plates.

14. The secondary battery as claimed in claim 13, wherein the electrode assembly is between the pair of the cap plates adjacent a lower part of the electrode assembly.

15. The secondary battery as claimed in claim 14, wherein respective ends of the electrode assembly are coupled to the pair of the cap plates.
